(19) United States
(12) Patent Application Publication
(10) Pub. No.: US 2011/0126175 A1
(43) Pub. Date: May 26, 2011

(54) DEBUGGING METHOD AND DEBUGGING DEVICE USING HARDWARE BREAKPOINTS

(75) Inventor: Shinji SUIZU, Kawasaki (JP)

(73) Assignee: FUJITSU LIMITED, Kawasaki-shi (JP)

(21) Appl. No.: 12/950,429

(22) Filed: Nov. 19, 2010

(30) Foreign Application Priority Data
Nov. 20, 2009 (JP) 2009-264451

(51) Int. Cl. G06F 9/44

(52) U.S. Cl. 717/129

(57) ABSTRACT

A method for debugging a software program using a hardware break, the software program being executed on an information processing device including a processing unit and storage means writable and readable by the processing unit, the method includes: setting a hardware breakpoint in a hardware breakpoint table, the hardware breakpoint table being stored in the storage means and intended to store a plurality of hardware breakpoints; determining a hardware breakpoint to be set next, on the basis of a hardware breakpoint stored in the hardware breakpoint table and the value of a program counter of the processing unit executing the software program to be debugged; storing the determined hardware breakpoint in a hardware break setting register, the hardware break setting register being provided inside the information processing device and used to set a hardware breakpoint; and debugging a software program using the hardware breakpoint table.

### CROSS-REFERENCE TO RELATED APPLICATION

This application is based upon and claims the benefit of priority of the prior Japanese Patent Application No. 2009-264451, filed on Nov. 20, 2009, the entire contents of which are incorporated herein by reference.

### FIELD

The embodiments discussed herein are related to a debugging method, a non-transitory computer-readable recording medium storing a debugging program, and a debugging device for debugging a software program to be executed by a processing unit.

### BACKGROUND

Examples of means for debugging a software program include a method of setting breakpoints using a debugger. There are two types of breakpoints: software breakpoints and hardware breakpoints.

A software breakpoint is set by replacing, with an instruction word for a break, an instruction at a point in a user program at which it is desired to stop execution of the user program. A break occurs when program processing passes through the point at which a software breakpoint is set. On the other hand, a hardware breakpoint is set in a hardware comparator included in, for example, a central processing unit (CPU) that is allowed to execute a software program to be debugged. A break occurs when program processing passes through the hardware breakpoint.

Accordingly, if a program is provided in a non-rewritable memory such as a ROM, software breakpoints, which require rewriting of the program memory, cannot be used and thus a hardware breakpoint is used. In actual CPUs, however, the number of hardware breakpoints settable at a time may be only one or two.

Japanese Laid-Open Patent Publication No.2001-67246 discloses an invention that, in order to set a new requested hardware breakpoint when all hardware breakpoints are in use, determines whether there is a breakpoint that can be placed on hold among the existing hardware breakpoints in use and, if such a breakpoint exists, places the breakpoint on hold to set the new requested breakpoint.

Japanese Laid-Open Patent Publication No.2000-267885 discloses an invention that copies, to a RAM area, a program stored in a ROM area and containing a program address at which it is desired to set a breakpoint, replaces a desired instruction code with a break code, executes the program, and writes it into the cache memory.

There is a limit to the number of hardware breakpoints settable in existing CPUs and the like. Thus, inconveniently, it may not be possible to set a sufficient number of hardware breakpoints for debugging purposes such as debugging of a program stored in a ROM.

In the invention disclosed in Japanese Laid-Open Patent Publication No. 2001-67246, no new hardware breakpoints can be set if there are no breakpoints that can be placed on hold. Also, the invention disclosed in Japanese Laid-Open Patent Publication No. 2000-267885 requires a RAM area to which a program stored in a ROM area is to be copied, as well as requires use of the cache memory.

Accordingly, an object of the present invention is to set hardware breakpoints using a simple method to debug software, with no concern about the number of breakpoints to be set as with software breakpoints.

### SUMMARY

According to an aspect of the embodiments, a method for debugging a software program using a hardware break, the software program being executed on an information processing device including a processing unit and a storage means writable and readable by the processing unit, the method including: setting a hardware breakpoint in a hardware breakpoint table, the hardware breakpoint table being stored in the storage means and intended to store a plurality of hardware breakpoints; determining a hardware breakpoint to be set next, based on a hardware breakpoint stored in the hardware breakpoint table and the value of a program counter of the processing unit executing the software program to be debugged; storing the determined hardware breakpoint in a hardware break setting register, the hardware break setting register being disposed inside the information processing device and used to set a hardware breakpoint; and debugging a software program using the hardware breakpoint table.

The object and advantages of the various embodiments will be realized and attained by means of the elements and combinations particularly pointed out in the claims.

It is to be understood that both the foregoing general description and the following detailed description are exemplary and explanatory and are not restrictive of the various embodiments, as claimed.

### BRIEF DESCRIPTION OF DRAWINGS

FIG. 1 illustrates an example of an implementation environment according to an embodiment of the present invention;

FIG. 2 illustrates an example of a system configuration according to this embodiment;

FIG. 3 illustrates a debugging process according to this embodiment;

FIG. 4 illustrates the debugging process according to this embodiment (continued);

FIG. 5 illustrates a hardware breakpoint table setting process according to this embodiment;

FIG. 6 illustrates an example setting of a hardware breakpoint table according to this embodiment;

FIG. 7 illustrates a hardware breakpoint change process according to this embodiment;

FIG. 8 illustrates a hardware breakpoint table deletion process according to this embodiment;

FIG. 9 illustrates an example of handling by a hardware break interrupt handler according to this embodiment;

FIG. 10 illustrates an example of handling by a handler for an interrupt other than a hardware breakpoint interrupt according to this embodiment; and

FIG. 11 illustrates an example program for explaining the operation of this embodiment.

### DESCRIPTION OF EMBODIMENTS

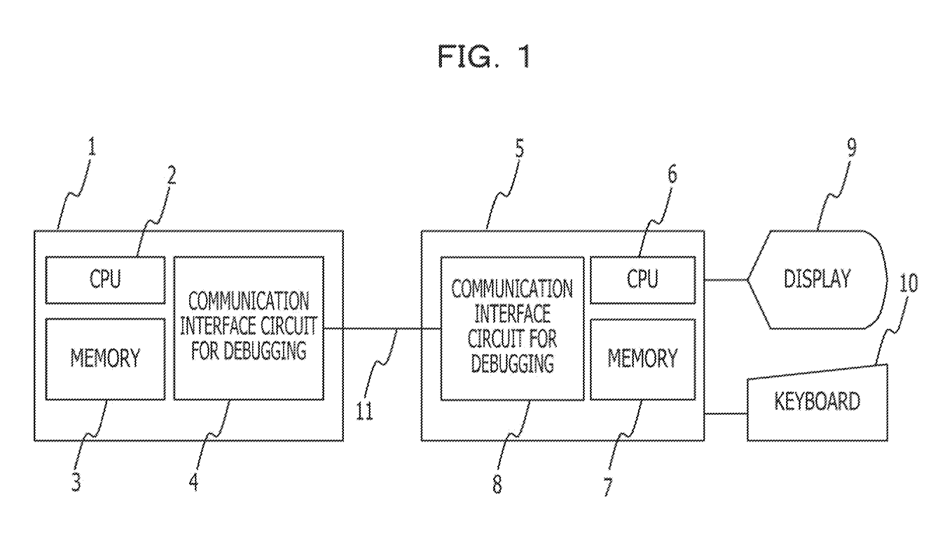

FIG. 1 illustrates an example environment in which this embodiment is implemented. In the example implementation environment of FIG. 1, a debugging device 1 and a debug operation terminal 5 are coupled via a communication interface 11 for debugging. The debug operation terminal 5 receives an operation for debugging a software program to be executed on the debugging device 1. In FIG. 1, the debugging device 1 includes a CPU 2, a memory 3, and a communication interface circuit 4 for debugging. The debug operation terminal 5 includes a CPU 6, a memory 7, and a communication interface circuit 8 for debugging. The debug operation terminal 5 receives a direction related to a debugging process from the user via a display 9 or a keyboard 10. The communication interface circuits 4 and 8 may be interface circuits such as LAN or serial interfaces, or other types of communication interfaces.

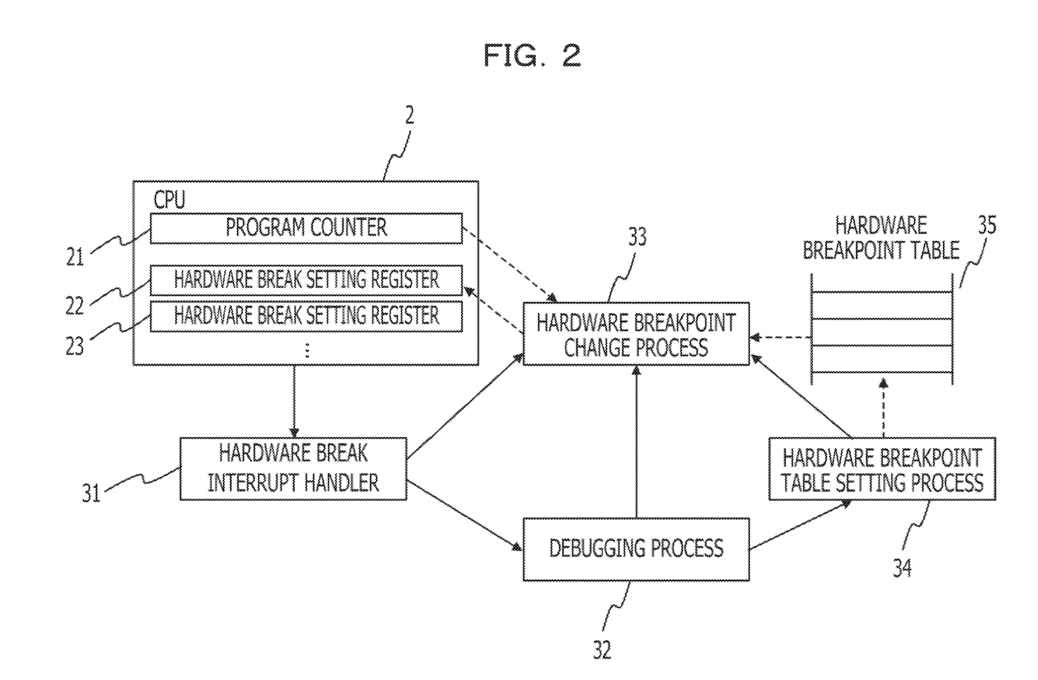

FIG. 2 illustrates a relationship between the CPU 2 of the debugging device 1 illustrated in FIG. 1 and a debugging program to be executed by the CPU 2 in debugging a software program using the debugging device 1. In FIG. 2, the CPU 2 includes a program counter 21 that stores the memory address of a program command to be executed and hardware break setting registers 22 and 23 that are used to set hardware breaks. The hardware break setting registers 22 and 23 are used when a hardware break interrupt or the like is controlled by a hardware break control circuit (not illustrated) of the CPU 2. In order to set, hardware breakpoints in the hardware break setting registers meeting the rules (to be discussed later) for determining hardware breakpoints, the number of hardware break setting registers is preferably two or more.

A hardware breakpoint table 35 in FIG. 2 is stored in the memory 3 or the like of the debugging device 1. The hardware breakpoint table 35 stores information such as the addresses of desired hardware breakpoints settings. A program for executing processes such as a hardware break interrupt handler 31, a debugging process 32, a hardware breakpoint change process 33, and a hardware breakpoint table setting process 34 illustrated in FIG. 2 is stored in the memory 3 or the like, and is executed by the CPU 2.

For example, if the value of the program counter matches a value set in the hardware break setting register 22 or 23 when the CPU 2 is executing the program, the above-mentioned hardware break control circuit generates a hardware break interrupt to an interrupt handling unit (not illustrated) of the CPU 2. When a hardware break interrupt occurs, the hardware break interrupt handler 31 is called. The hardware break interrupt handler 31 refers to the value of the program counter 21 and information stored in the hardware breakpoint table 35 to call the debugging process 32 or hardware breakpoint change process 33. Specifically, if the value of the program counter 21 at the time when the hardware break interrupt is generated matches the value of one of the hardware breakpoint addresses stored in the hardware breakpoint table 35, the debugging process 32 is called. Conversely, if the value of the program counter 21 at the time when the hardware break interrupt has occurred does not match the values of any hardware breakpoint addresses stored in the hardware breakpoint table 35, the hardware breakpoint change process 33 is called.

The debugging process 32 executes a debugging process according to a debugger command given by the user via the debug operation terminal 5. The debugging process 32 then calls the hardware breakpoint change process 33 or hardware breakpoint table setting process 34. Specifically, if the user enters a breakpoint setting command during the debugging process 32, the hardware breakpoint table setting process 34 is called; otherwise, the hardware breakpoint change process 33 is called.

The hardware breakpoint table setting process 34 sets the hardware breakpoint table 35 under conditions to be discussed later. Subsequently, the hardware breakpoint change process 33 is called. The hardware breakpoint change process 33 refers to the value of the program counter 21 and the values set in the hardware breakpoint table 35 and then sets one or two hardware breakpoints to be set in either or both of the hardware break setting registers 22 and 23.

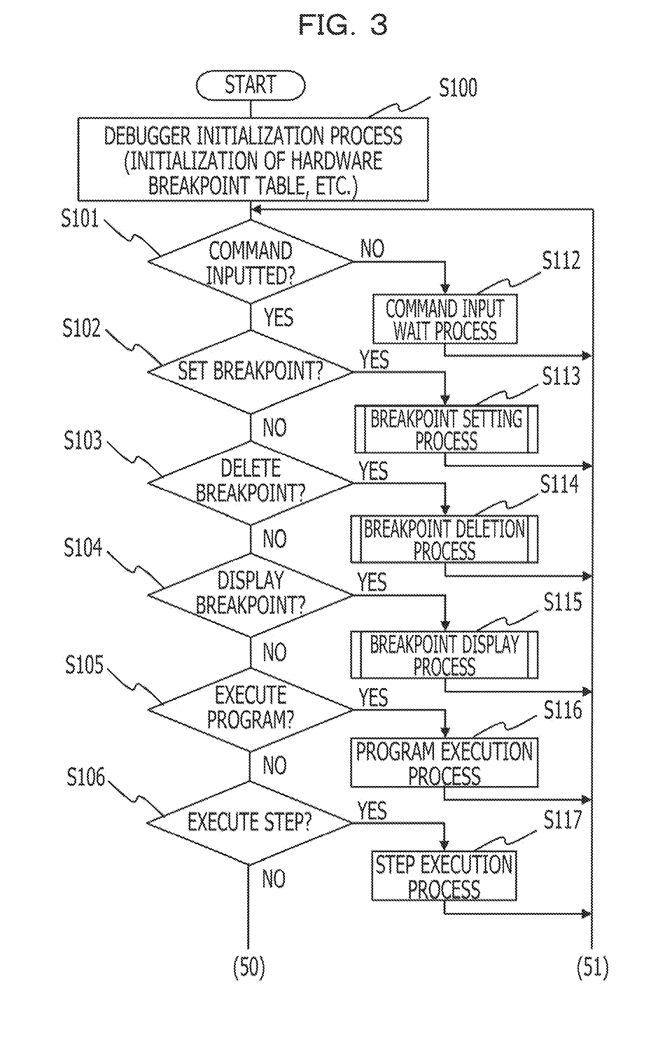

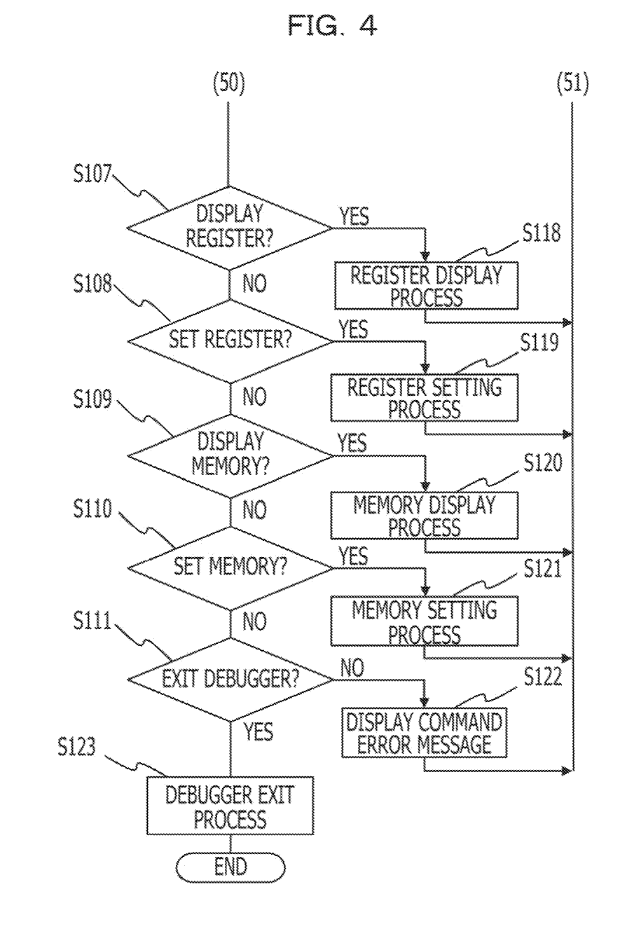

FIGS. 3 and 4 illustrate the debugging process according to this embodiment. FIGS. 3 and 4 jointly illustrate a flowchart of the entire debugging process. (50) and (51) of FIG. 4 correspond to (50) and (51), respectively, of FIG. 3.

When the debug executor enters a debugger command from the debug operation window of the debug operation terminal 5, the debugger command is sent to the CPU 2 via the communication interface for debugging. Upon receipt of the debugger command, the CPU 2 starts a debugging program routine to process the debugger command. The processes constituting the debugging process will be described with reference to FIGS. 3 and 4.

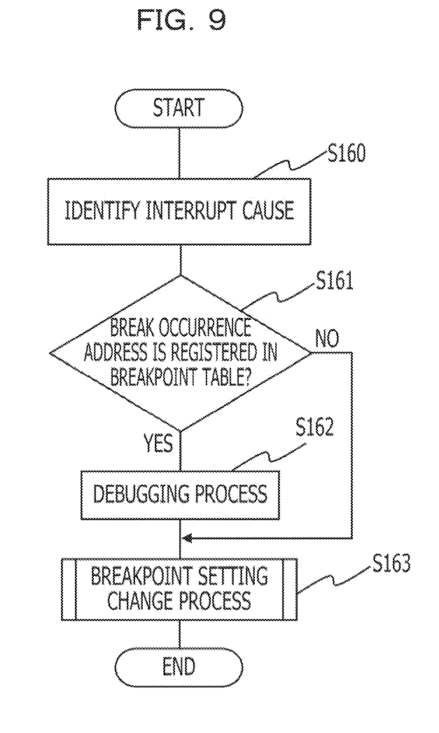

The debug operation terminal 5 and debugging device 1 are powered on to start a debug operation program to be executed by the debug operation terminal 5, as well as the debugging process to be executed by the debugging device 1. Thus, a debugger initialization process in S100 of FIG. 3 is executed. The debugger initialization process in S100 involves initialization of the hardware breakpoint table. Operations S101 and S112 wait for the entry of a debugger command until the debug executor enters a debugger command via the debug operation terminal 5. The debugger initialization process in S100 is executed when starting the debugger for the first time. When a debugging process is called by another process, for example, by the hardware break interrupt handler illustrated in FIG. 9, the process in S100 may be omitted.

When the debug executor enters a debugger command via the debug operation terminal 5 (S101: YES), a process corresponding to the entered command is called by the debugging process. Specifically, the content of the entered command is determined in S101 to S111 of the debugging process, and processes according to the entered command are called in S112 to S122. The details will be described below.

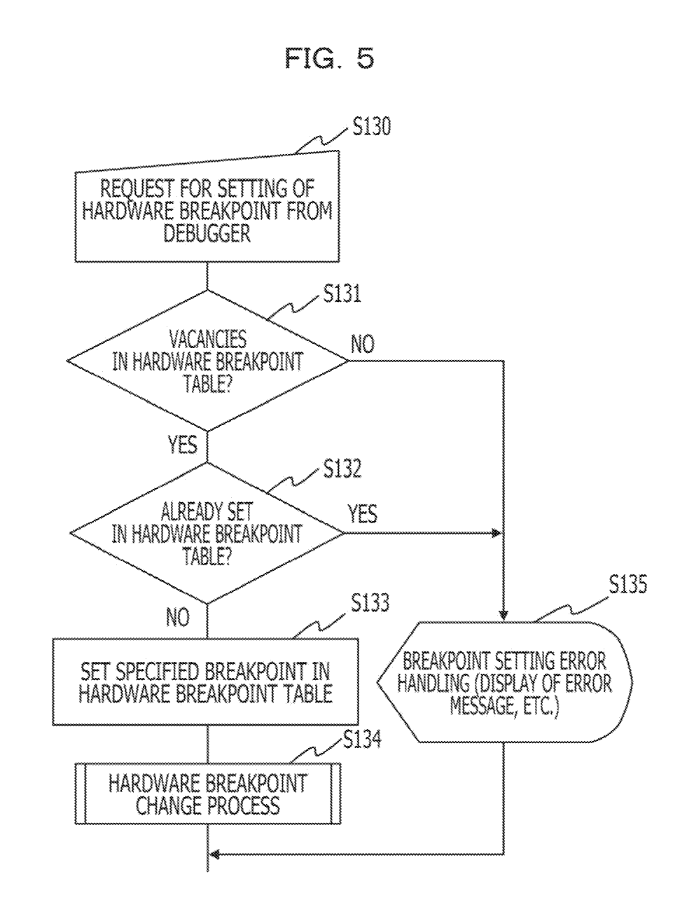

When a hardware breakpoint setting command is entered as a debugger command (S102: YES), the debugging process calls a hardware breakpoint table setting process in S113 illustrated in FIG. 5, which will be discussed later.

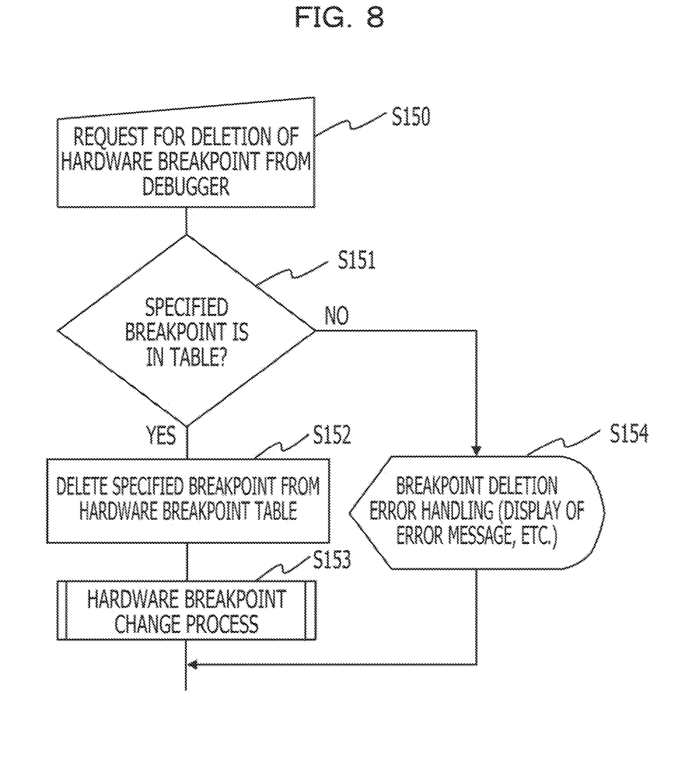

When a hardware breakpoint deletion command is entered as a debugger command (S103: YES), the debugging process calls, in S114, a hardware breakpoint table deletion process illustrated in FIG. 8, which will be discussed later.

When a hardware breakpoint display command is entered as a debugger command (S104: YES), the debugging process calls a hardware breakpoint table display process in S115. The hardware breakpoint display process outputs a list of breakpoints present on the breakpoint table onto the debugger screen.

When a program execution command is entered as a debugger command (S105: YES), the debugging device 1 starts the program in S116.

When a step execution command is entered as a debugger command (S106: YES), the debugging device 1 executes a program step in S117.

When a register display command is entered as a debugger command (S107: YES), the debugging process calls a register display process in S118. The register display process displays the content of a register specified by the command on the debugger screen.

When a register setting command is entered as a debugger command (S108: YES), the debugger process calls a register setting process in S119. The register setting process sets a value specified by the command in the register specified by the command.

When a memory display command is entered as a debugger command (S109: YES), the debugging process calls a memory display process in S120. The memory display process displays the content of the memory at an address specified by the command on the debugger screen.

When a memory setting command is entered as a debugger command (S110: YES), the debugging process calls a memory setting process in S121. The memory setting process sets content specified by the command in memory at the address specified by the command.

When a debug completion command is entered as a debugger command (S111: YES), the debugging process executes a debug completion process, thus, completing the debugging process.

When a command other than the above-mentioned commands is entered as a debugger command (S111: NO), the debugging process displays a command error message on the debugger operation screen of the debug operation terminal 5 in S122. In this embodiment, the debugging process includes the various processes (S113 to S122) of FIGS. 3 and 4; however, it may include other processes.

FIG. 5 illustrates the details of the hardware breakpoint table setting process in S113 of FIG. 3. When a hardware breakpoint setting command is entered as a debugger command, the debugging process calls the hardware breakpoint table setting process illustrated in FIG. 3. The hardware breakpoint table, which contains management information of the set hardware breakpoints, is stored in the memory or the like of the debugging device.

When a hardware breakpoint setting command is entered from the debugger in S130, whether there are vacancies in the hardware breakpoint table is determined in S131. If there are vacancies in the hardware breakpoint table (S131: YES), whether or not a hardware breakpoint specified by the debugger command has already been set in the hardware breakpoint table is determined in S132. If the specified hardware breakpoint has not been set yet (S132: NO), the address and set time of the specified breakpoint are set in the hardware breakpoint table in S133.

When a hardware breakpoint is set in S133, in S134 a hardware breakpoint change process is called to update the hardware breakpoints. Specifically, the hardware breakpoint change process refers to the value of the program counter and the values set in the hardware breakpoint table, and then sets the specified hardware breakpoints in the hardware break setting register(s).

If it is determined in S131 that there are no vacancies in the hardware breakpoint table, or if it is determined in S132 that the specified hardware breakpoint has already been set, breakpoint setting error handling is executed in S135. In the error handling of S135, the error state is reported to the debug executor, for example, by displaying error information on the display 9 connected to the debug operation terminal 5. The debug executor determines what kind of process is to be subsequently executed, in accordance with the description of the error displayed in the error handling in S135.

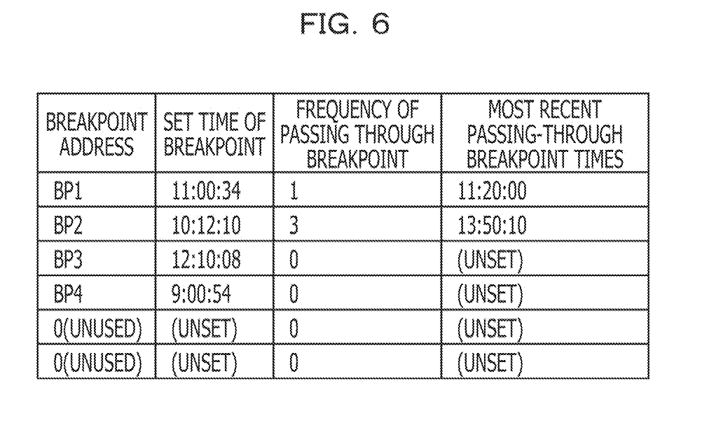

FIG. 6 illustrates an example setting of the hardware breakpoint table according to this embodiment. The number of entries in the hardware breakpoint table 35 at which hardware breakpoints can be set is obtained as the number of the second and later rows of the hardware breakpoint table illustrated in FIG. 6. The number of hardware breakpoint entries may be increased to a larger entry number than that in the example illustrated in FIG. 6 as long as the storage area storing the hardware breakpoint table, such as the memory, accommodates the larger number of entries.

When, in S133 of FIG. 5, breakpoint addresses (BP1 to BP4) other than 0 are set at breakpoint addresses of the hardware breakpoint table, the entries of the hardware breakpoint table are put “in use.” In the hardware breakpoint table, the entries having “0” set at breakpoint addresses are put in “unused.” When setting hardware breakpoint addresses in the hardware breakpoint table, the set times of the hardware breakpoints are also set, whereas the frequencies of passing through hardware breakpoints and the times of passing through breakpoints most recently are cleared. For example, when the debug executor displays a list of hardware breakpoints, the set times, the passing-through frequencies, and the most recent passing-through times of the hardware breakpoints are displayed as reference information for debugging. If the passing-through frequency of a breakpoint is “0,” the most recent passing-through time thereof remains “unset.”

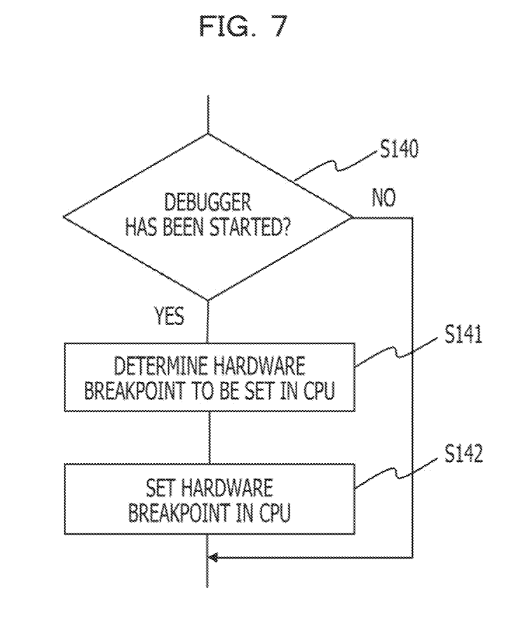

FIG. 7 illustrates the hardware breakpoint change process according to this embodiment. The hardware breakpoint change process determines in S140 whether the debugger has already been started. If the debugger has been started (S140: YES), it determines, in S141, hardware breakpoints to be set in the CPU.

In S141, hardware breakpoints to be set in the CPU are determined according to the following rules. Rule 1: Breakpoints set in the hardware breakpoint table are set in the CPU in the descending order of closeness to the current program counter. Rule 2: However, if there is a branch instruction or subroutine return instruction in a position closer to the program counter than a hardware breakpoint closest to the current program counter, a hardware breakpoint is set at the branch destination address of the branch instruction or subroutine return instruction. Rule 3: If the branch instruction or subroutine return instruction in Rule 2 is a conditional branch instruction, a hardware breakpoint is set not only at the branch destination address, but also at the address at which an instruction subsequent to the branch instruction is placed.

In S142, the hardware breakpoint to be set in the CPU, determined in S141, is set in the hardware break setting registers 22 and 23 of the CPU 2 of the debugging device 1.

If a debugger process is not running, for example, after the debugger exits upon receipt of a debug completion command in S111 of FIG. 4 (S111: YES), there is a danger that a hardware breakpoint change process may be executed, causing the software program to malfunction. Accordingly, when the debugger is not running (S140: NO), it is desirable not to execute the hardware breakpoint change process.

FIG. 8 illustrates the hardware breakpoint table deletion process (S114) of FIG. 3. When a hardware breakpoint deletion command is entered in the debugger, the debugger processing routine calls the hardware breakpoint table deletion process (FIG. 8) in S114 of FIG. 3.

When the hardware breakpoint table deletion command is specified, whether the specified hardware breakpoint is present or not in the hardware breakpoint table is checked in S151 of FIG. 8. If the specified hardware breakpoint is present (S151: YES), in S152, 0 is set at the breakpoint address of the entry of the hardware breakpoint table whose deletion has been specified, putting the entry in “unused”.

After deleting the hardware breakpoint in S152, the hardware breakpoint table deletion process calls the hardware breakpoint change process (FIG. 7) in S153 to update the hardware break setting registers 22 and 23.

If it is determined in S151 that the hardware breakpoint specified in S151 is not present, a breakpoint deletion error handling is called in S154. In S154, the details of the error are reported to the debug executor, for example, via the display 9 connected to the debug operation terminal 5.

When a program execution command is entered in the debugging process (S105 of FIG. 3: YES), the debugging device 1 executes the program in the program execution process (S116 of FIG. 3). When a step execution command is entered in the debugging process (S106 of FIG. 3: YES), the debugging device 1 executes a program step in the step execution process (S117 of FIG. 3). Subsequently, when the program counter reaches a hardware breakpoint set in the hardware break setting registers 22 and 23, a hardware break interrupt occurs. This calls the hardware break interrupt handler.

FIG. 9 illustrates an example of handling by the hardware break interrupt handler according to this embodiment. The hardware break interrupt handler illustrated in FIG. 9 identifies the cause of the hardware break interrupt in S160. That is, the hardware breakpoint interrupt handler copes with the cause of the interrupt and executes a process for preventing the same interrupt from occurring again after completion of the process by the interrupt handler. Specifically, in S160, a process such as clearing of a bit corresponding to the cause of the interrupt of an interrupt status register corresponding to the interrupt that occurred is executed.

If it is determined in S161 that the address at which the hardware break has occurred is registered in the hardware breakpoint table (S161: YES), the debugging process is called according to the hardware break in S162.

In the debugging process of S162, the software program is debugged according to the debugger command given by the debug executor while, for example, the display or rewrite of the register or memory content illustrated in S118 to S121 of FIG. 4 is executed. Upon completion of the debugging process, a hardware breakpoint setting change process (FIG. 7), where a hardware breakpoint to be set next is set, is called in S163.

If it is determined in S161 that the address at which the hardware break has occurred is not registered in the hardware breakpoint table (S161: NO), S163 is called to update the hardware break setting registers.

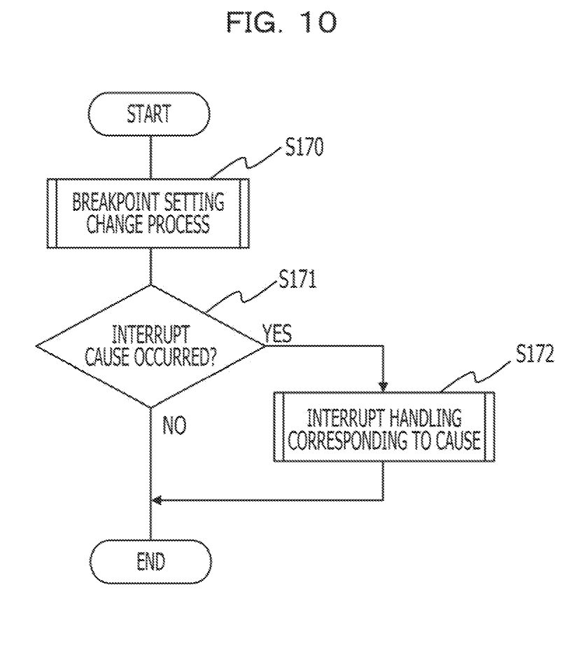

FIG. 10 illustrates an example of handling by an interrupt handler when an interrupt other than a hardware break interrupt occurs. When an interrupt other than a hardware break interrupt occurs, the program branches to an interrupt handler corresponding to the interrupt. At that time, for setting a hardware break also for the interrupt handler, it is necessary to set a hardware breakpoint again. Accordingly, the hardware breakpoint change process is called in the first S170 of the interrupt handler of FIG. 10 to update the hardware break setting registers. Subsequently, if it is determined in S171 that an interrupt cause has occurred, an interrupt handling corresponding to the interrupt cause is executed in S172.

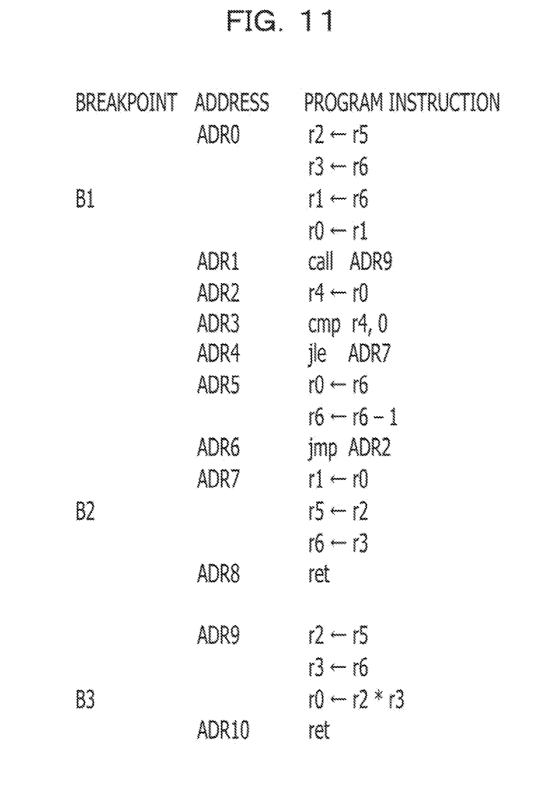

FIG. 11 illustrates an example program for explaining the operation according to this embodiment. Using an example program instruction of FIG. 11, an example of a hardware breakpoint setting change according to this embodiment will be described below.

First, the notation used in FIG. 11 will be described. Among the example program instructions in FIG. 11, “r0 to r6” represent registers. For example, the description “r2←r5” means that the content of the register r5 is stored in the r2 register. “call” at the address ADR1 represents a subroutine call instruction, and “call ADR9” means that call branches to ADR9. “cmp r4,0” at the address ADR3 represents an instruction for comparing the value stored in the register r4 with 0. “jle” at the address ADR4 represents a conditional branch instruction, and “jle ADR7” means that, upon receipt of the result of the preceding instruction cmp, jle branches to ADR7 if r4=0. “jump” at the address ADR6 represents an unconditional branch instruction, and “jump ADR2” means that jump branches to ADR2 unconditionally. “ret” at the address ADR8 represents an unconditional subroutine return instruction.

In FIG. 11, it is assumed that the number of hardware breakpoints settable in the CPU is two and that breakpoint addresses to be registered first in the hardware breakpoint table are B1, B2, and B3.

Hereafter, assuming that the value of the initial program counter (PC) is ADR0, an example of a hardware breakpoint setting change according to this embodiment will be described with reference to FIG. 11.

First, as described above, B1, B2, and B3 are set in the hardware breakpoint table as breakpoint addresses. When a hardware breakpoint setting command is entered in the debugging process (S102 of FIG. 3: YES), the hardware breakpoint setting process (S113 of FIG. 3) is called. In the hardware breakpoint setting process, the breakpoint addresses B1, B2, and B3 are registered in the hardware breakpoint table and then the hardware breakpoint setting change process is called (S134 of FIG. 5). Thus, the hardware breakpoint of the CPU 2 is set at the breakpoint address B1 closest to the ADR0, at which the program counter is located. That is, the breakpoint address B1 is set at the hardware break setting register 22 or 23.

Subsequently, when a program execution command of the debugger is entered (S105 of FIG. 3: YES), the program to be debugged is started. Specifically, the program instructions are executed sequentially, starting with the program instruction at the address ADR0 of FIG. 11.

When the program counter (PC) reaches the address B1 of FIG. 11, a hardware break interrupt occurs, which transfers control from breakpoint processing by the debugger to command processing by the debugger (S160 to S162 of FIG. 9).

When a program execution command of the debugger is entered again (S105 of FIG. 3: YES), the breakpoint setting change process is executed before control is transferred to the program (S163 of FIG. 9). A branch instruction is present at the address ADR1 between the address B1 of FIG. 11 specified by the program counter at this time point and the address B2 of the next breakpoint. Accordingly, the breakpoint setting change process sets the address ADR9, which is the branch destination of the unconditional subroutine call instruction at the address ADR1, as a CPU hardware breakpoint. That is, the ADR9 is set in the hardware break setting register 22 or 23 of the CPU 2. Control is then transferred to the program.

When the unconditional subroutine call instruction at the ADR1 is executed so that the program counter reaches the ADR9, a hardware break interrupt occurs again, since the ADR9 is set in the hardware break setting register. However, the ADR9 is not registered in the hardware breakpoint table, so the breakpoint change process is called without transferring control to the debugger (S161, S163 of FIG. 9). Subsequently, the breakpoint change process sets the address B3, which is the breakpoint address closest to the address ADR9 of FIG. 10 indicated by the program counter at that point in time, as the next CPU hardware breakpoint.

When the program counter reaches the address B3 of FIG. 10, a hardware break interrupt occurs again. As described above, B3 is set in the hardware breakpoint table, so control is transferred from breakpoint processing by the debugger to command processing thereby (S161, S162 of FIG. 9).

When a program execution command of the debugger is entered again, the breakpoint change process is executed before control is transferred to the program (S163 of FIG. 9). Since a return instruction is present at the ADR10 subsequent to the address B3 of FIG. 10 indicated by the program counter at this time point, the breakpoint change process sets the ADR2, which is the return destination of the unconditional subroutine call instruction at the ADR10, as a CPU hardware breakpoint. Control is then transferred to the program.

When the unconditional subroutine return instruction at the address ADR10 of FIG. 10 is executed so that the program counter reaches the ADR2, a breakpoint interrupt occurs. However, the ADR2 is not registered in the hardware breakpoint table, so the hardware breakpoint change process is called without transferring control to the debugger (S163 of FIG. 9). The hardware breakpoint change process sets the ADR7, which is the branch destination of the conditional branch instruction at the ADR4, and the ADR5, which is the address of the instruction subsequent to the conditional branch instruction, as CPU hardware breakpoints.

When the program counter reaches the address ADR4 of FIG. 10, the conditional branch instruction is executed and branched. Thus, the program counter reaches the address ADR7 so that a breakpoint interrupt occurs. However, the address ADR7 is not registered in the hardware breakpoint table, so the breakpoint change process is called without transferring control to the debugger (S163 of FIG. 9). Subsequently, the hardware breakpoint change process sets the address B2, which is closest to the address ADR7 of FIG. 10 indicated by the program counter at that point in time, as the next CPU hardware breakpoint.

If, after the program counter reaches the address ADR4 of FIG. 10, the conditional branch instruction is executed but is not branched, the program counter reaches the address ADR5. Since the hardware breakpoint has been set at the address ADR5, a breakpoint interrupt occurs. However, the address ADR5 is not registered in the hardware breakpoint table, so the hardware breakpoint change process is called without transferring control to the debugger (S163 of FIG. 9). A branch instruction is present at the address ADR6 between the address ADR5 of FIG. 10, at which the program counter is located at this point in time, and the address B2, which has been set as the next hardware breakpoint. Accordingly, the hardware breakpoint change process sets the address ADR2, which is the branch destination of the unconditional branch instruction at the address ADR6, as the next CPU hardware breakpoint.

By executing a similar process, the debugging process of the software program is continued.

What is claimed is:

1. A method for debugging a software program using a hardware break, the software program being executed on an information processing device including a processing unit and storage means writable and readable by the processing unit, the method comprising:
setting a hardware breakpoint in a hardware breakpoint table, the hardware breakpoint table being stored in the storage means and intended to store a plurality of hardware breakpoints;
determining a hardware breakpoint to be set next, on the basis of a hardware breakpoint stored in the hardware breakpoint table and the value of a program counter of the CPU executing the software program to be debugged;
storing the determined hardware breakpoint in a hardware break setting register, the hardware break setting register being disposed inside the information processing device and used to set a hardware breakpoint;
when, after startup of the software program, the value of the program counter matches a value stored in the hardware break setting register so that a hardware break interrupt occurs, determining whether the value of the program counter at which the hardware break interrupt has occurred is set in the hardware breakpoint table; and
executing a debugging process using a hardware break if the value of the program counter at which the hardware break interrupt has occurred is set in the hardware breakpoint table.

2. The method for debugging a software program according to claim 1, further comprising:
when an interrupt has occurred in the processing unit, determining a hardware breakpoint to be set next, on the basis of a hardware breakpoint stored in the hardware breakpoint table and the value of the program counter of the processing unit executing the software program to be debugged; and
storing the determined hardware breakpoint in the hardware break setting register.

3. The method for debugging a software program according to claim 1, further comprising:
when there occurs a need to change a hardware breakpoint in a debugging process of the software program, determining a hardware breakpoint to be set next, on the basis of a hardware breakpoint stored in the hardware breakpoint table and the value of the program counter of the processing unit executing the software program to be debugged; and
storing the determined hardware breakpoint in the hardware break setting register.

4. The method for debugging a software program according to claim 1, further comprising:
if there is no branch instruction between an instruction address currently indicated by the program counter of the processing unit executing the software program to be debugged and a breakpoint address, the breakpoint address being an instruction address later than the instruction address currently indicated by the program counter and being closest to the current value of the program counter among breakpoints set in the hardware breakpoint table, determining hardware breakpoints to be set next in the descending order of closeness to the current value, starting with the closest breakpoint address; and
if there is a branch instruction between the instruction address currently indicated by the program counter and the closest breakpoint address, determining the branch destination address of the branch instruction as a hardware breakpoint to be set next.

5. The method for debugging a software program according to claim 4, further comprising
if the branch instruction is a conditional branch instruction, setting a hardware breakpoint not only at the branch destination address of the conditional branch instruction, but also at the address of an instruction subsequent to the conditional branch instruction.

6. A non-transitory computer-readable recording medium storing a debugging program for debugging a software program using a hardware break, the software program being executed on an information processing device including a central processing unit and storage means writable and readable by the processing unit, the debugging program causing the processing unit to execute:
setting a hardware breakpoint in a hardware breakpoint table, the hardware breakpoint table being stored in the storage means and intended to store a plurality of hardware breakpoints;
determining a hardware breakpoint to be set next on the basis of a hardware breakpoint stored in the hardware breakpoint table and the value of a program counter of the processing unit executing the software program to be debugged;
storing the determined hardware breakpoint to be set next in a hardware break setting register, the hardware break setting register being provided inside the information processing device and used to set a hardware breakpoint; and
when, after startup of the software program, the value of the program counter matches a value stored in the hardware break setting register so that a hardware break interrupt occurs, determining whether the value of the program counter at which the hardware break interrupt has occurred is set in the hardware breakpoint table, using a hardware break interrupt handler for handling an occurring hardware break interrupt and, if the value of the program counter at which the hardware break interrupt has occurred is set in the hardware breakpoint table, executing a debugging process using a hardware break.

7. A debugging device for debugging a software program, comprising:
a processing unit that executes the software program;
storage means writable and readable by the processing unit;
a hardware breakpoint table that is stored in the storage means and stores a plurality of hardware breakpoints; and
a hardware break setting register used to set a hardware breakpoint, wherein
when the value of the program counter of the processing unit matches a value stored in the hardware break setting register so that a hardware break interrupt occurs after startup of the software program, the processing unit stops execution of an instruction of the software program in order to debug the software program, if the value of the program counter at which the hardware break interrupt has occurred is set in the hardware breakpoint table, and
when an interrupt is generated in the processing unit or when a need to change a hardware breakpoint to another in a debugging process of the software program occurs, the processing unit determines a hardware breakpoint to be set next based on a hardware breakpoint stored in the hardware breakpoint table and the value of the program counter of the processing unit executing the software program to be debugged, and stores the determined hardware breakpoint to be set next in the hardware break setting register.

8. The debugging device according to claim 7, further comprising
an operation unit, wherein
a hardware breakpoint is set in the hardware breakpoint table on the basis of hardware breakpoint information entered via the operation unit.
